(19) United States
(12) Patent Application Publication
(10) Pub. No.: US 2009/0180850 A1
(43) Pub. Date: Jul. 16, 2009

(54) GARBAGE SHREDDING PROCESS AND PRODUCTS THEREBY

(76) Inventor: Donna K. Jackson, Fort Worth, TX (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/352,549

(22) Filed: Jan. 12, 2009

Related U.S. Application Data
(60) Provisional application No. 61/020,651, filed on Jan. 11, 2008.

(51) Int. Cl. B65G 65/00; B65G 1/02

(52) U.S. Cl. 414/304; 414/808

(57) ABSTRACT

Systems have been invented for canisterizing waste whereby the waste is at least one of retrieved from subject canisters and drained from the canisters, using fluids, hydraulic or related pressure mechanisms. Plunging mechanisms, magnetics and related filtration and filtering systems facilitate ready disposal and create, waste efficiencies of scale.

### CROSS-REFERENCE TO RELATED APPLICATION

The instant application claims full Paris Convention priority of, and incorporates expressly by reference, U.S. Provisional Application Ser. No. 61/020,651 filed Jan. 11, 2008.

### BACKGROUND

1. Field

This disclosure relates to systems for storing and disposing of waste. Particularly, this disclosure relates to systems that pick up, for example, for waste from restaurants.

2. General Background

Many ways exist to pay people to dispose of trash, however, none of them easily accommodate the build-up of waste that could have usage as reclaimed matter for generating energy (e.g., ethanol) in a way the is economically feasible, or generates substantial quantities needed for alternate energy sources without burdensome cost and timing issues.

### SUMMARY

Briefly stated, systems have been invented for canisterizing waste, whereby the waste is at least one of retrieved from subject canisters and drained from the canisters, using fluids, hydraulic or related pressure mechanisms. Plunging mechanisms, magnetics and related filtration and filtering systems facilitate ready disposal and create vast efficiencies of scale.

According to embodiments, specially designed canisters hold waste until fluid pressure provides draining with hose mechanisms and gravity driven drainage sub-components.

According to embodiments, Plunging mechanisms, magnetics and related filtration and filtering systems facilitate ready disposal and create vast efficiencies of scale.

### DRAWINGS

The above-mentioned features and objects of the present disclosure will become more apparent with reference to the following description taken in conjunction with the accompanying drawings wherein like reference numerals denote like elements and in which:

FIG. 1 is a schematic of an exemplary canister according to teachings of the present disclosure;

FIG. 2 is another schematic of an exemplary canister according to teachings of the present disclosure.

### DETAILED DESCRIPTION

The present inventor has discovered that canisters can be used to gather waste which can then be stored, harvested, or otherwise used as receptacles to create substrate matter for alternate energy, e.g., ethanol production.

Expressly incorporated herein by reference as if fully set forth herein are: U.S. Application Serial No. 2007/0298488 filed Dec. 27, 2007; U.S. Application Serial No. 2007/0029247 filed Feb. 8, 2007; U.S. Application Serial No. 2005/0247647 filed Nov. 10, 2005; U.S. Application Serial No. 2005/0028689 filed Feb. 10, 2005; U.S. Application Serial No. 2004/0206698 filed Oct. 21, 2004; U.S. Application Serial No. 2003/0183094 filed Oct. 21, 2004; U.S. Application Serial No. 2003/0006327 filed Jan. 9, 2003; U.S. Application Serial No. 2003/0003568 filed Jan. 2, 2003; U.S. Pat. No. 7,296,693 filed on Nov. 11, 2007; U.S. Pat. No. 7,108,788 filed Sep. 19, 2006; U.S. Pat. No. 6,925,928 filed on Aug. 9, 2005; U.S. Pat. No. 6,640,701 filed Nov. 4. 2003; and U.S. Pat. No. 5,538,143 filed on Jul. 23, 1996.

The present inventor has discovered that canisters for housing and concentrating waste can later be used as a base fuel or substrate for energy generation.

Accordingly to embodiments, ingress means for allowing economically efficient movement of the waste.

According to embodiments, egress means for allowing the waste to be removed periodically, or at an interval desired.

According to embodiments, interface means for allowing a transport system to add or remove the waste with at least one power source selected from the group of fluids, mechanical forces, gravity and other power systems.

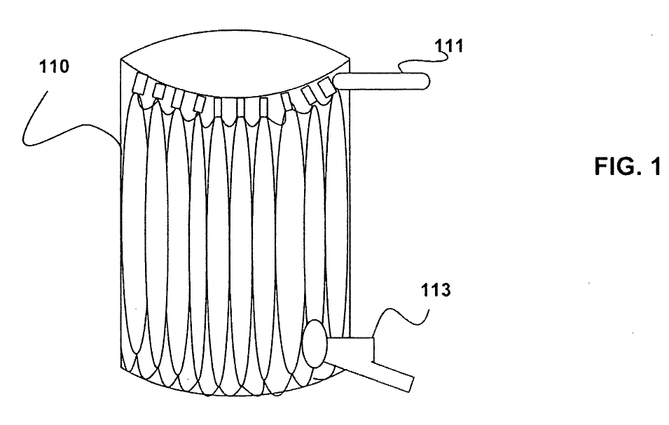

FIG. 1 shows a basic design whereby refuse, for example, restaurant refuse, can be held, stored gathered for later pick-up by a truck, trucking system or alternate means for transporting the same to an alternate energy generating facility.

Canister 110, has ingress 111 and egress 113 means for example a hose-based system and a drain. Fluid (not shown) is transferred in and stored until periodic pick-up, eliminating a cost to the host of the canister.

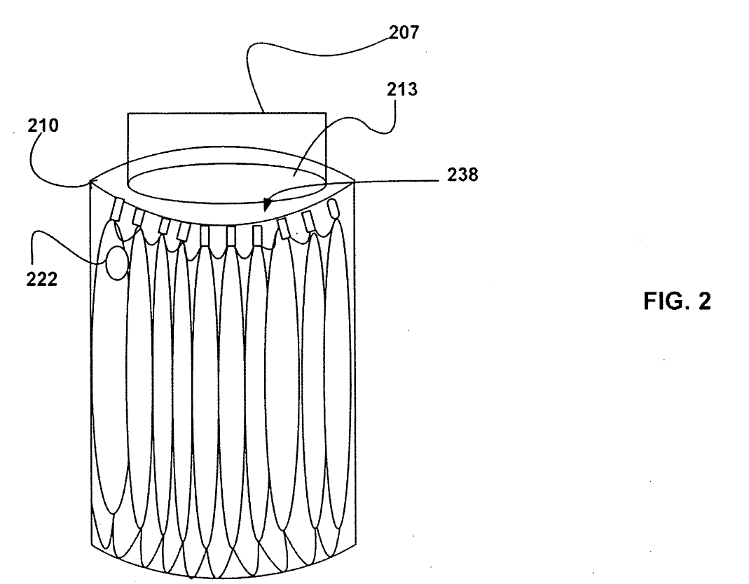

Turning now also to FIG. 2, unit 210 has ingress and egress (not shown) mechanisms function as they do in the first illustrative embodiment, however plunger elements 222 and magnetic filtration attachment 207 including magnetic plate/element 213 (for example pulls silverware from the mixture to enable enhanced flow), is shown along with clockwise and counterclockwise aperture guard 238. Artisans understand that such openings are readily interchangeable, working with fittings in the transport systems, and can allow for economically efficient transfers. In other words, the exemplary canister can be custom or retrofitted into trucks, for example.

Those skilled in the art readily understand that systems for transport can either interface directly with the canisters (removing their respective contents with suction, fluidics and the like mechanisms) or move the canisters themselves.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicants).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may nor have been able to anticipate, all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. In a system for collecting refuse for later use as alternate energy, the improvement comprising;
at least a canister for housing and concentrating waste later used as a base fuel or substrate for energy generation;
ingress means for allowing economically efficient movement of the waste;
egress means for allowing the waste to be removed periodically, or at an interval desired; and
interface means for allowing a transport system to add or remove the waste with at least one power source selected from the group of fluids, mechanical forces, gravity and other power systems.

2. The system of claim 1, further comprising at least a hose and a drain.

3. The system of claim 2, further comprising magnetics, plunger systems and a counter-clockwise and clockwise aperture regulation mechanism.

4. A process for canisterizing unwanted garbage and removing a desired slurry, which comprises, in combination:
arraying at least a receptacle for gathering waste;
filling the at least a receptacle;
emptying the at least a receptacle; and
harvesting a desired effluent.

5. The process of claim 4, wherein a magnetic system removes undesired solid object and certain metals prior to the emptying step.

6. The process of claim 4, using the system of claim 3.

7. The process of claim 6, wherein the garbage is from food already consumed by humans, such as in a restaurant, cafeteria, or the like eatery.

8. The process of claims 7, including transport vehicles fro carrying the resultant slurry to a processing plant or site for generating energy.

9. The products by the process of claim 8.

10. Products by the process of claim 7.

11. Products by the process of claim 5.

12. Products by the process of claim 4.

13. A kit, comprising in combination:
at least a canister for housing and concentrating waste later used as a base fuel or substrate for energy generation; and
direction for use.
